(19) United States
(12) Patent Application Publication
(10) Pub. No.: US 2012/0304511 A1
(43) Pub. Date: Dec. 6, 2012

(54) Method and Image for Representing Wine

(76) Inventor: Ian Charles Buxton, Sandton (ZA)

(21) Appl. No.: 13/515,412

(22) PCT Filed: Nov. 29, 2010
(86) PCT No.: PCT/IB10/55467

§ 371 Date: Aug. 8, 2012

(30) Foreign Application Priority Data
Dec. 14, 2009 (ZA) 2009/08895

(51) Int. Cl. G09F 3/00; B42D 15/00

(52) U.S. Cl. 40/299.01; 283/81

(57) ABSTRACT

The invention discloses an image for representing a wine, which includes an image that includes at least one illustration of an item, and each item indicating at least one charactenstic of the wine. The image is adapted to be provided in printed, electronic and/for digital format. The characteristic is a member selected from the group consisting of the flavour of the wine, the body of the wine; and the acidity of the wine. The image assists persons who have not tasted the wine to imagine an interpretation of the flavour of the wine.

### FIELD OF INVENTION

The present invention relates to a method and image for representing wine.

More particularly, the present invention relates to a method and image for representing wine, in particular the aromas, taste and intensity by means of a printed image which may be used on a label, a container for wine, an article of promotional material in respect of a wine, a wine catalogue or a digital image which may be used in electronic media such as email and the internet, screen display and a signal.

### BACKGROUND TO INVENTION

Existing methods of communicating the taste of a wine rely on linguistic descriptions of the wine. These descriptions, which are sometimes referred to as “tasting notes”, are either written or spoken. For example, a wine may be verbally described as: “Showing cassis and pencil shavings on the nose, while the palate is intense but not weighty. Good fruit expression”.

In order for the communication to be effective, the person receiving the description has to interpret and understand the linguistic description, and from this information attempt to assess an imaginary smell and taste. This requires a reasonable grasp of the language used in the description and also requires an imaginative effort on the part of the person receiving the description.

Existing linguistic descriptors address a plurality of characteristics or elements of the experience of a wine. In this patent specification, “characteristic” includes all elements of the experience of a wine. These characteristics or elements may be a member selected from the group consisting of:
(a) the flavour of the wine;
(b) the body of the wine; and
(c) the acidity of the wine.

It will be appreciated that the flavour of the wine is the tastes that it has or evokes. In this patent specification, “flavour” includes both taste and smell. The body of the wine refers to the affect of a number of characteristics including alcohol, residual sugar and phenolic compounds, and that a full bodied wine is said to have a heavier mouth feel. The acidity is a function of both the type of acids present and their strength giving different experiences when tasted. Thus, for example, tartaric acid has a sharply sour taste whereas lactic acid has a softer taste, which may be referred to as “milky”.

It is an object of the invention to suggest a method and image for representing wine, which will assist in overcoming these problems.

### SUMMARY OF INVENTION

According to the invention, an image for representing a wine, includes
(a) an image that includes at least one illustration of an item, and
(b) each item indicating at least one characteristic of the wine.

The items may not include grapes and/or wine.

The image may be presented in printed format and/or electronic/digital format.

The image may include a background.

The background may be at least one item and/or consist of variable colour.

The colour(s) may also indicating at least one characteristic of the wine.

The characteristic may be a member selected from the group consisting of
(a) the flavour of the wine,
(b) the body of the wine; and
(c) the acidity of the wine.

The item or colour may indicate a plurality or all of the characteristics.

The items may be selected from one or more members of the group consisting of fruit, grasses, spices, herbs, flowers, baked items (for example bread, cake and toast), meat, vegetables, yeast, smoke, dust, stone, wood, metals, confectionary, fluids (for example coffee, tea and kerosene, milk), nuts, crops (for example tobacco and wheat), agricultural produce, cigars and cigars boxes, material (for example silk), environments (for example forest floor)

The items and/or illustrations may be adapted to assist persons who have not tasted the wine to imagine an interpretation of the flavour of the wine.

The illustration(s) of the item(s) may be a photograph and/or drawing and/or graphic and/or computer generated image.

The colouring of any item and of its background may be selected to indicate one or more characteristic of the wine.

The colour of the item(s) or background may be adjusted to indicate the intensity of the flavour, the weight of the body, or the style and intensity of the acid.

The image may undergo at least one of the following adjustments:
(a) opacity;
(b) hue;
(c) colour saturation;
(d) lightness (or value); and
(e) filter.

The image may be adapted to represent that the experience of the wine may vary during the consumption of the wine, while the wine is being smelt and tasted in the mouth.

To indicate the changes in taste the items in the image may be positioned in an arrangement in which the order of the items in the arrangement indicates how the experience of the wine develops over time.

The arrangement may extend across the picture, the items at one end of the arrangement indicating the initial experience and the items at the opposite end of the arrangement indicating the finish, the items in the middle of the arrangement indicating the mid-palate experience, the mid-palate experience being the experience into which the initial experience develops into over time, the mid-palate experience developing over time into the finish.

The items which indicate the finish may be depicted as being in front of the items which indicate the mid-palate experience, which may be depicted as being in front of the items indicating the initial experience.

The arrangement may extend across the picture with the items at an end of the arrangement indicating the initial experience, and the items at the opposite end of the arrangement indicating the finish.

The arrangement may extend diagonally across the picture with the items at an end of the arrangement proximate the top left corner and/or section of the picture indicating the initial experience, and the items at the opposite end of the arrangement proximate the bottom right corner and/or section of the picture indicating the finish.

The colour used in the background may vary across the picture to indicate how the experience of the wine develops over the length of time that the wine is in the mouth.

The image may also include a container (typically a bottle or a wine glass) to enable the person(s) to associate the olfactory and gustatory representations with that of a wine product.

The bottle may include the brand label to further enable the person(s) to associate the taste with the brand.

The image may include a written description of the items and colours representing the experience of the wine to enable the person(s) to clarify the meaning and sequence of the illustrations.

The image may be used for at least one member selected from the group consisting of
(a) labels;
(b) containers;
(c) promotional and/or documentary material;
(d) wine catalogues and/or menus;
(e) digital images; and
(f) signals.

Also according to the invention, a label includes an image for representing wine as herein described.

The label may be for a wine container, for example a wine bottle.

Yet further according to the invention, a container includes an image for representing wine as herein described.

The container may hold wine.

The image may be printed on a label that is affixed to the container.

The image may be printed on the container, for example the container may be a carton and the picture may be printed on the carton.

Yet further according to the invention, an article of promotional or documentary material in respect to wine, includes an image for representing wine as herein described.

The article of promotional or documentary material may be a leaflet, a label, a display item for a shelf in a retail outlet, a magazine article or a poster.

The article of promotional material may include wording to promote the wine or report on it.

Yet further according to the invention, a wine catalogue includes a plurality of names of wines, each name of a wine may have an associated image for representing picture as herein described.

The catalogue may be a wine list or wine menu.

The catalogue may be provided on a sheet of paper or in book form

The catalogue may include, in association which each name and picture of a wine, a written description of the flavour of the wine, thereby to enable a person to use specific taste indicators to select a wine and to clarify the meaning of the illustrations, in case of doubt.

Yet further according to the invention, a digital material or image includes an image for representing wine as herein described.

The digital material or image may include wording to promote the wine.

The digital material or image may for example be included in a web page or in an embedded file or attachment to an e-mail.

The digital material or image may be a screen attached to a shelf in a retail outlet.

The digital material or image may be an online catalogue of wine.

Yet further according to the invention, a signal for producing, on a display screen, an image for representing wine as herein described.

The signal may be analogue or digital.

The display screen may for example be a television screen or a computer monitor.

Yet further according to the invention, a method of representing wine includes the steps
(a) of identifying at least one characteristic of at least one wine;
(b) of associating at least one item to indicate at least one identified characteristic of the wine; and
(c) of creating an image for representing wine incorporating at least one illustration of the item(s).

The characteristic(s) of the wine(s) may be identified by means of tasting the wine(s) and/or laboratory analysis of the wine(s).

Yet further according to the invention, a method of selecting and/or picking at least one wine, includes the steps
(a) of viewing at least two images for representing wine as herein described;
(b) of selecting and/or picking at least one wine based on the images for representing wine.

The step of selecting and/or picking the wine(s) may be based on at least one of the following:
(a) the item(s);
(b) the background;
(c) the colour(s);
(d) at least one characteristic of the wine;
(e) the flavour of the wine;
(f) the body of the wine; and
(g) the acidity of the wine;
(h) the adjustments;
(i) the varying experience of the wine during the consumption of the wine.

Yet further according to the invention, a method of classifying at least one wine, includes the step of classifying at least one wine according to an image for representing wine as herein described specifically constructed for the wine.

The step of classifying may be based on at least one of the following:
(a) the item(s);
(b) the background;
(c) the colour(s);
(d) at least one characteristic of the wine;
(e) the flavour of the wine;
(f) the body of the wine; and
(g) the acidity of the wine;
(h) the adjustments;
(i) the varying experience of the wine during the consumption of the wine.

Yet further according to the invention, a method for educating persons and/or communicating information about wine, which includes the step of providing an image for representing wine as herein described to at least one person to enable the person(s) to interpret and/or understand the characteristics of the wine(s).

### BRIEF DESCRIPTION OF DRAWINGS

The invention will now be described by way of example with reference to the accompanying schematic drawings.

In the drawings there is shown in:

FIG. 1: a face-on view of an image for representing wine in accordance with the invention, showing the variation of the background colouring of the picture of the image;

FIG. 2: a diagrammatic, line drawing showing another face-on view of the image for representing wine shown in FIG. 1; and

FIG. 3: a face-on view of the image for representing wine in accordance with the invention, showing the variation of the background colouring of the picture of the image; incorporating a branded bottle and the description text; and

FIG. 4: a computer screen shot of a gradient editor interface used to construct an image for representing wine in accordance with the invention.

### DETAILED DESCRIPTION OF DRAWINGS

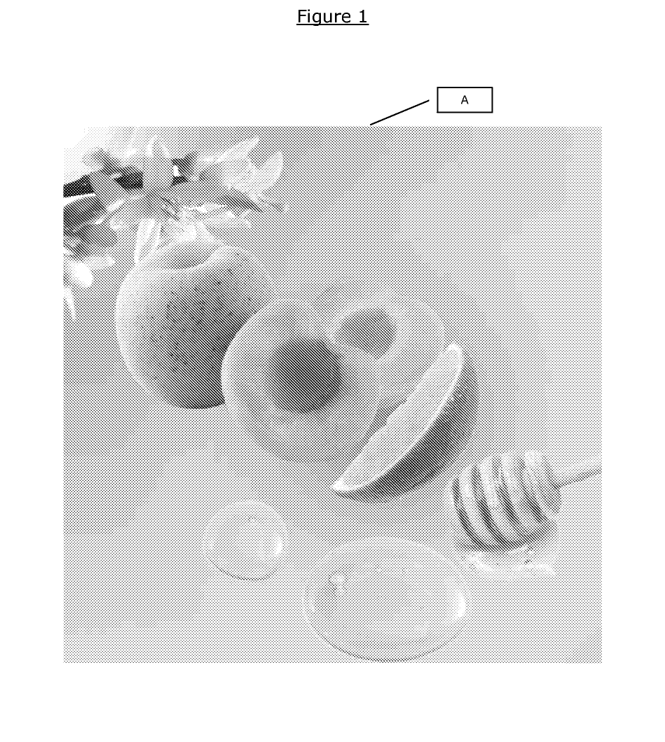

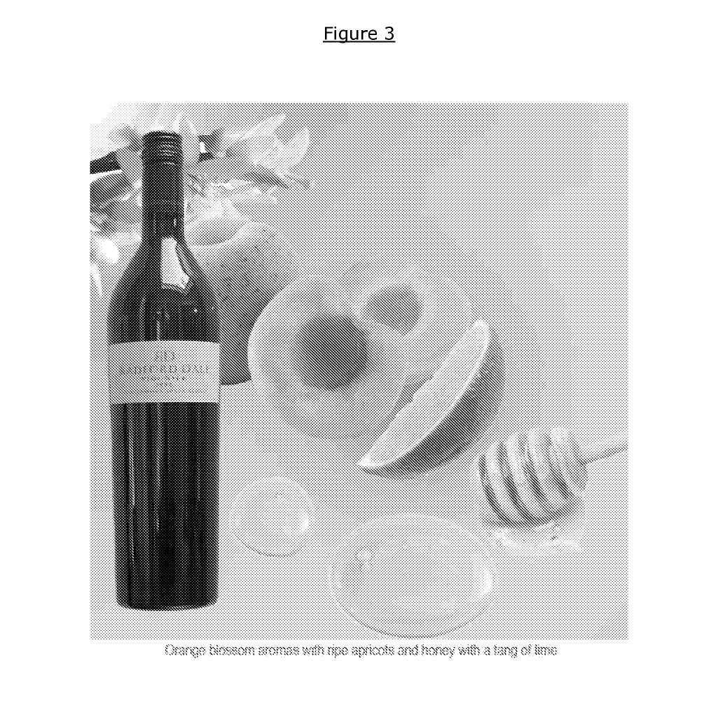

In FIGS. 1 to 3, an image for representing wine in accordance with the invention, generally indicated by reference letter A, is shown.

The method and image for representing wine in accordance with the invention aims to facilitate the imaginary assessment of the experience of a wine by representing these characteristics in images.

By means of this invention, the experience of a wine can be communicated without requiring familiarity of any particular language by the addressee of the communication. Further, it is believed that the invention makes use of the capacity of a person's brain to respond more efficiently to a visual trigger than a linguistic trigger, particularly when the trigger relates to food. The phrase, “a picture is worth a thousand words”, is a recognition of the phenomenon that a visual experience in humans can be an extremely fast and compelling mechanism for creating a response. An example this phenomenon is when saliva is produced in a person's mouth in response to an image of a cut lemon. It will be appreciated that the invention can assist in the promotion of a wine and can assist consumers when they make consumption or purchasing decisions.

According to the first aspect of the invention there is provided an image that includes illustrations of items, none of which being grapes or wine, and a background which may be an item or comprise of colour. The items and the colours are indicating at least one characteristic of a wine. The characteristic may be a member selected from the group consisting of the flavour of the wine, the body of the wine and the acidity of the wine. The item or colour may indicate a plurality or all of the characteristics.

The invention also extends to a method of representing wine which includes the steps
(a) of identifying at least one characteristic of at least one wine;
(b) of associating at least one item, generally none of which being grapes or wine, being adapted to indicate at least one identified characteristic of the wine; and
(c) of creating an image for representing wine incorporating at least one illustration of the item(s).

The characteristic of the wines are identified by means of tasting the wines and/or laboratory analysis of the wines.

The invention also extends to and assists in a method of selecting and/or picking wines, which includes the steps
(a) of viewing images for representing wine as herein described;
(b) of selecting and/or picking the wines based on the images for representing wine.

The step of selecting and/or picking the wine(s) is based on at least one of the following:
(a) the item(s);
(b) the background;
(c) the colour(s);
(d) at least one characteristic of the wine;
(e) the flavour of the wine;
(f) the body of the wine; and
(g) the acidity of the wine;
(h) the adjustments;
(i) the varying experience of the wine during the consumption of the wine.

The invention also extends to and assists in a method of classifying wines, includes the step of classifying the wines according to an image for representing wine as herein described specifically constructed for the wines.

The step of classifying can be based on the following:
(a) the item(s);
(b) the background;
(c) the colour(s);
(d) at least one characteristic of the wine;
(e) the flavour of the wine;
(f) the body of the wine; and
(g) the acidity of the wine;
(h) the adjustments;
(i) the varying experience of the wine during the consumption of the wine.

The invention also extends to a method for educating persons and/or communicating information about wine, which includes the step of providing an image for representing wine as herein described to at least one person to enable the person(s) to interpret and/or understand the characteristics of the wine(s).

The images for representing wines can thus be used to educate people to learn more about the characteristics of wines and also to communicate information about wines.

### Items

The items may be selected from one or more members of the group consisting of fruit, grasses, spices, herbs, flowers, baked items (for example bread, cake and toast), meat, vegetables, yeast, smoke, dust, stone, wood, metals, confectionary, fluids (for example coffee, tea and kerosene, milk), nuts, crops (for example tobacco and wheat), agricultural produce, cigars and cigars boxes, material (for example silk), environments (for example forest floor)

It will be appreciated that the inclusion of an item in the picture does not mean that all persons who taste a wine would necessarily, and in the absence of seeing the picture, associate the flavour of the wine with the item. Rather, the inclusion of an item in the picture is to assist persons who have not tasted the wine to imagine an interpretation of the flavour of the wine.

The illustrations of the items can photographs and/or drawings and/or graphics and/or computer generated images.

### Colour

The colouring of any item and of its background may be selected to indicate one or more characteristic of the wine. For example, if the wine has a flavour which is reminiscent of lemons, the colouring of both the lemon item and of the background colouring may include a lemon yellow and if the wine has a flavour which is reminiscent of melons, the item and background colouring may include a melon green.

It will be appreciated that the colour of the item or background may be adjusted to indicate the intensity of the flavour, the weight of the body, or the style and intensity of the acid.

A suitable colour for indicating these characteristics can conveniently be selected if the picture is created by a software graphics package that includes a facility for adjusting the opacity, hue, colour saturation and lightness of an item or background colour, along with a facility to applying a colour filter to the picture in order to adjust all characteristics in a consistent manner. An example of such a software graphics is sold under the trade name “Photoshop CS3”.

### Adjustments

The adjustments are described here with reference to the HSV (Hue Saturation Value) model of describing colour:

Opacity: A item or background that is not transparent is said to be 100% opaque. By selecting a reduced opacity the item becomes transparent. This transparency may indicate one or more of the following: a reduction in flavours intensity, a reduction acid intensity and a reduction in body weight.

Hue: The hue is the actual colour of an item or background. Adjusting the hue may indicate a change in the flavour indicated. For example adjusting the hue of a red cherry to a much darker purple or black cherry will indicate a different flavour and ripeness.

Colour Saturation: Colour saturation refers to the saturation is the ratio of the dominant colour wavelength to other wavelengths in the colour. Adjusting the saturation indicates a change in the characteristic that the colour is representing. For example increasing the saturation of a lemon yellow indicates an increase in the lemon flavour and acidity.

Lightness (or Value): How light or dark a colour is referred to either as a colour lightness or value. In terms of a spectral definition of colour, value describes the overall intensity or strength of the light. Adjusting the lightness or value of an item or background indicates a change in the characteristic that the colour is representing. For example increasing the lightness of an image indicates a reduction of the body of the wine.

Filter: A filter can be applied to a image or to an item within the image. There are many types of filter each having a specific effect. For example a colour filter may be applied in order to modify the image to indicate the presence of a characteristic such as tannin.

### Arrangement

It will be appreciated that the experience of the wine may vary during the consumption of the wine, while the wine is being smelt and tasted in the mouth.

To indicate the changes in taste the items in the image may be positioned in an arrangement in which the order of the items in the arrangement indicates how the experience of the wine develops over time. The arrangement may extend across the picture, the items at one end of the arrangement indicating the initial experience and the items at the opposite end of the arrangement indicating the finish, the items in the middle of the arrangement indicating the mid-palate experience, the mid-palate experience being the experience into which the initial experience develops into over time, the mid-palate experience developing over time into the finish.

The items which indicate the finish may be depicted as being in front of the items which indicate the mid-palate experience, which may be depicted as being in front of the items indicating the initial experience. It will be appreciated that this perspective can reinforce the indication of the variation of the experiences over time.

The arrangement may thus extend across the picture with the items at an end of the arrangement indicating the initial experience, and the items at the opposite end of the arrangement indicating the finish. For example, the arrangement may extend diagonally across the picture with the items at an end of the arrangement proximate the top left corner and/or section of the picture indicating the initial experience, and the items at the opposite end of the arrangement proximate the bottom right corner and/or section of the picture indicating the finish. It will be appreciated that this example of the arrangement utilises the left to right, top to bottom approach used by some cultures to interpret an image and in particular read written communications. Accordingly, if, for example, the picture is intended to be used in a culture which interprets images differently, the use of perspective and arrangement of items will differ to conform with the predominant mode of interpretation used in that culture.

The colour used in the background may vary across the picture to indicate how the experience of the wine develops over the length of time that the wine is in the mouth. Thus, the background colouring may vary across the picture according to the variation of the experience of the wine over time. For example, the background colouring proximate the top, left corner and/or section of the picture indicating the initial experience and the background colouring proximate the bottom, right corner and/or section of the picture indicating the final experience which in the practice of wine tasting is referred to as the “finish”.

Association with Wine and the Wine Brand

The image may also include a container (typically a bottle or a wine glass). It is envisaged that this will enable the person to associate the olfactory and gustatory representations with that of a wine product. If the bottle carries the brand label then it is envisaged that this will further enable them to associate the taste with the brand.

### Interpretation of the Representation

The image may include written description of the items and colours representing the characteristics or experience of the wine, thereby to enable a person to clarify the meaning and sequence of the illustrations, in case of doubt.

### Utilisation of the Image

(a) Label

According to a second aspect of the invention there is provided a label which bears a picture The picture may be as hereinbefore described with reference to the first aspect of the invention.

The label may be for a wine container, for example a wine bottle.

(b) Container

According to a third aspect of the invention there is provided a container which bears a picture. The picture may be as hereinbefore described with reference to the first aspect of the invention.

The container may hold wine. The picture may be printed on a label that is affixed to the container. Instead, the picture may be printed on the container, for example the container may be a carton and the picture may be printed on the carton.

(c) Promotional and Documentary Material

According to a fourth aspect of the invention there is provided an article of promotional or documentary material in respect to wine, which article includes picture. The picture may be as hereinbefore described with reference to the first aspect of the invention.

The article of promotional or documentary material may for example be a leaflet, a label, a display item for a shelf in a retail outlet, a magazine article or a poster.

The article of promotional material may include wording to promote the wine or report on it.

(d) Wine Catalogue

According to a fifth aspect of the invention there is provided a wine catalogue which includes a plurality of names of wines, each name of a wine having an associated picture. Each picture may be as hereinbefore described with reference to the first aspect of the invention.

The catalogue may be a wine list. The catalogue may be provided on a sheet of paper or in book form

The catalogue may include, in association which each name and picture of a wine, a written description of the flavour of the wine, thereby to enable a person to use specific taste indicators to select a wine and to clarify the meaning of the illustrations, in case of doubt.

(e) Digital Image

According to a sixth aspect of the invention there is provided an image in digital format which includes a picture. The picture may be as hereinbefore described with reference to the first aspect of the invention except that is presented in a digital format.

The image may include wording to promote the wine. The image may for example be included in a web page or in an embedded file or attachment to an email. It may be a screen attached to a shelf in a retail outlet. It may be an online catalogue of wine.

(f) Signal

According to a seventh aspect of the invention there is provided a signal for producing, on a display screen, an image which includes a picture. The picture may be as hereinbefore described with reference to the first aspect of the invention

The signal may be analogue or digital. The display screen may for example be a television screen or a computer monitor.

### Example

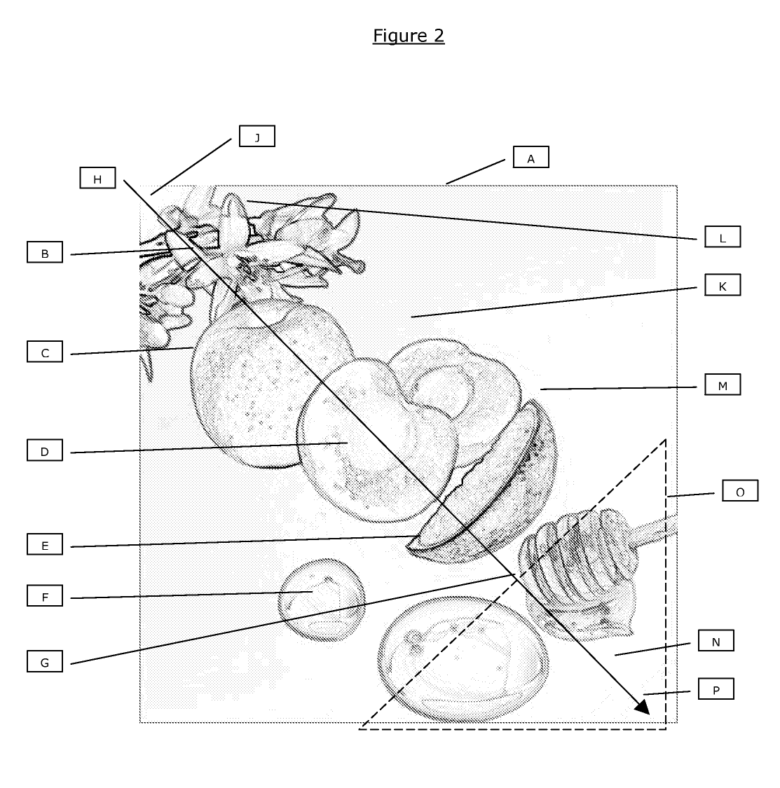

Referring to FIG. 2, the image A includes illustrations of a plurality of items for indicating an characteristic of a wine, including orange blossom (B), peach (C), cut peaches (D) lime (E), honey (F) and honey on a honey stick (G).

In this example each of the items B, C, D, E and F indicate the flavour of the wine; the items F and G also indicating a somewhat viscous, finishing experience.

The items B, C, D, E, F and G are positioned in an arrangement H in which the order of the items in the arrangement indicates how the experience of the wine develops over the length of time that the wine is in the mouth. The arrangement H extends diagonally across the picture A.

The items B and C, at an end of the arrangement H proximate the top left corner J of the picture A indicate the initial olfactory and gustatory experience. The items D, E indicate the mid palate flavour (i.e. the mid-palate flavour being the flavour into which the initial flavour develops into overtime). The items F,G indicate the finishing flavour of the wine.

The items F, G which indicate the finish, are depicted as being in front of the items D, E, which indicate the mid-palate flavour, which are depicted as being in front of the items B, C, which indicate the initial experience.

The background colouring K of the picture A is selected to indicate the flavour of the wine, the body of the wine and the degree of acidity of the wine. The background colouring K of the picture A varies across the picture A to indicate how the experience of the wine develops over the length of time in which the wine is in the mouth, the background colouring L proximate the top, left corner J of the picture A indicating the initial experience and the background colouring N proximate the bottom, right corner P of the picture A indicating the final experience i.e. the finish.

More particularly, the background colouring L is a soft white with hints of peach, indicating the initial flavour depicted by the items B and C. The background colouring at M is dark green blended with peach, indicating the mid palate flavour depicted by the items D and E. The background colouring at N is a rich honey gold, indicating the flavour of the item G and full bodied almost sweet finish. The size of area demarcated by the dotted line O, which has been inserted in opinion the picture for the purpose of illustrating the invention but is not part of the image, the line O showing more or less the area of the finish colouring, the size of the area indicating the longevity of the finish.

The background colouring K at L, M and N are chosen to emphasize and reinforce the colours of the items proximate thereto. The background colouring K is of a moderate degree of saturation indicating a moderate acidic content. The background colouring K at L, M and N is of a moderate to high opacity indicating a medium to full body to the wine. The hues of the background colouring K at L, M and N, all being moderately pastel, indicate that the wine generally has a moderately soft style of acidity, the hue of the background colouring K at L (a pale peach) being somewhat brighter than the hues at M and N (peach and gold), thus indicating that the initial experience is slightly lighter than the mid-palate experience and the finish. The moderately pastel hues of the background colouring K are achieved by selecting an appropriate hue in the graphics software package, “Photoshop CS3”, and applying a colour filter thereto.

The colour values according to the RGB colour representation paradigm of the background colouring K at L are [Red: 251; Green: 238; Blue: 230], at M are [Red: 219; Green: 194; Blue: 140] and at N are [Red: 243; Green: 213; Blue: 130]. The corresponding colour values according to the CMYK colour representation paradigm of the background colouring K at L are [Cyan: 1%; Magenta: 6%; Yellow: 7%; Black: 0%], at M are [Cyan: 15%; Magenta: 21%; Yellow: 51%; Black: 0%], and at N are [Cyan: 5%; Magenta: 14%; Yellow: 58%; Black: 0%].

The transitions of the background colouring K are smooth (FIG. 1), indicating a smooth wine.

### Steps for Producing an Image for Representing Wine

Colour and images are not included randomly in the image for representing wine; instead the visual image follows a formula that enables the mind to interpret what it is seeing. A image for representing wine is made up of a number of components. It should be interpreted by reading the diagram from top left which represents the initial taste and sensations of the wine, down to the bottom right which represents the taste and sensations at the finish.

| Component | Represented By |
|---|---|
| Fruit/Other | Images of the fruits or taste indicators: The initial tastes up |
| Taste | in the upper left quadrant, those present at the finish are |
| | represented in the bottom right quadrant. |
| Fruit Flavour | Background colour: The background colour is chosen to |
| Intensity | emphasise which of the taste indicator objects should be |
| | considered to be most relevant and the extent to which it is |
| | present. It is sampled from the objects being used in the |
| | image. For Example: A strong lemon flavour would be |
| | represented by a bright yellow. A softer melon flavour by a |
| | paler yellow/green. |
| Acid | Background saturation: Acid is indicated by the degree of |
| intensity | saturation of the colour used in the background. A strongly |
| | acidic sensation is represented by a heavily saturated |
| | version of the required fruit/image colour. |
| Body | Background opacity: Body in a wine is a function of a |
| | number of characteristics such as alcohol, residual sugar, |
| | and phenolic tastes. A full bodied wine is said to have a |
| | heavier mouth feel. This sensation is represented by the |
| | opacity of the background colours used. For Example. A |
| | thin fruit flavour is represented by thinner, more opaque |
| | tone, whereas a full bodied wine will have no opacity in |
| | the background at all. |

The construction of a wine picture therefore has a process.

### 1. Tasting and Documenting

The wine is tasted to ascertain
(a) the fruit and other flavours to be represented;
(b) the sequence in which they are tasted in the wine;
(c) the intensity of the flavours;
(d) the style and intensity of the acid present; and
(e) the body of the wine in terms of the mouth feel of alcohol, residual sugar and other characteristics.

### 2. Image Selection

The images for taste are selected. These should be realistic images that evoke either a gustatory or olfactory experience. The number of images selected will depend upon the complexity of the taste of the wine. The minimum number should be two images, the maximum is seven. The ideal number of taste images is five.

### 3. Fruit/Taste Indicators: Item Layers

The images selected in step two are then added in layers to the image. The intention is to include the item so that is identifiable and proportional to the presence of that taste in the wine, but not so large that it obscures a large proportion of the background. Each object is selected using the graphics software to ensure that only the image of the fruit or taste indicator is shown—none of its original background should be used.

A particular object can be added in multiples to indicate a strong dominance of the flavour it represents.

Initial taste sensations are added at the back of the picture positioned in the top left quadrant, surrounded by the background colours that represent the initial taste.

Items are then added diagonally to the image with later tastes being positioned more towards the bottom right quadrant (the finish).

### 4. Background Creation: Fruit/Image Colour Sampling

The background is created by blending and merging the colours of the tastes to be represented. This is done using image editing software, and in particular a gradient editor or “gradient tool” which is operated by a user by means of a gradient editor interface. When producing the labels, an option is chosen by a user by means of the gradient editor whereby points along a diagonal line of points extending from the top left hand corner and/or section to the bottom right hand corner and/or section of the background are represented by corresponding points along a horizontal line shown in the gradient editor interface. The gradient editor enables a user to specify the colour at any point on the line shown in the gradient editor interface, and thus at a corresponding point in the diagonal line of points in the background, and to specify the rate and point at which one colour merges/transforms into the other. The colour of the remainder of the background corresponds to the colours of the diagonal line of points in accordance with a preset pattern which the user selects from a number of possible options provided by the gradient editor. Not all the fruit/object tastes need to be sampled, only those which represent the dominant taste at any one time.

The diagonal line of points represents a time-line of the taste experience, the beginning of the taste experience being represented by points of the diagonal at the top left hand corner and/or section of the background and the end of the taste experience being represented by the points of the diagonal at the bottom right hand corner and/or section of the background.

The colour of the first fruit is sampled until a colour is established that is evocative of the taste. This colour is set at the extreme left of the gradient line.

The next taste is then sampled and a marker is placed upon the line representing this colour at the point in time where that taste becomes dominant.

This process continues until all the required tastes (not necessarily all the images) have been sampled and placed upon the time line. An image with more samples indicates a more complex wine. The final taste is placed at the extreme right (i.e. the end) of the taste.

### 5. Background Creation: Taste to Taste Transition

The points at which the tastes become dominant has been established. The smoothness with which this transition takes place is represented by the gradient smoothness control. A value of 100% represents the smoothest transition possible. If there is a particular need to make any transition more particular abrupt than the default value chosen this is achieved by adjusting the point at which the transition happens using the “location” control.

6. Background Creation: Body representation

In a similar way to the addition of colour the gradient tool allows the user to define the opacity at various points along the time line.

The opacity at the start should be determined and set, similarly the opacity at the end should be determined ad set.

If required additional “opacity stops” can be placed on the timeline to set the body at any particular point. The values chosen are intended as rough approximations of the mouth feel of the wine, the relative movement between the values indicates any changes as the wine is savoured.

If required the rate at which the opacity changes can be adjusted using the location controls.

### 7. Background Creation: Base Layer

The gradient tool is then used to create a background for the image by stretching the pre-programmed line from the top left corner and/or section of the proposed image. The size or shape of the image is not prescribed, however a square is standard.

### 8. Adjustment Layer: Acid Intensity

Should it be necessary to indicate a factor about the acid content of the wine this is done by using an “adjustment layer” to either decrease or increase the level of colour saturation over all or part of the background image.

A particularly strong acid would be indicated by increasing the colour saturation by a number of percentage points until the colour is more vivid and intense. This adjustment layer can apply to the whole image or to sections of the image.

Similarly a soft acid is indicated by reducing the saturation.

### 9. Bottle/Wine in a Glass: Taste Association

In order to assist the picture viewer to associate the tastes represented with wine, a sample bottle of the wine can be added either as part of the picture or at the side of the picture. This solution allows for the brand associations to be made available to the person seeing the picture. Alternatively, the same effect without the brand associations can be achieved by displaying a glass containing wine of the appropriate colour and hue.

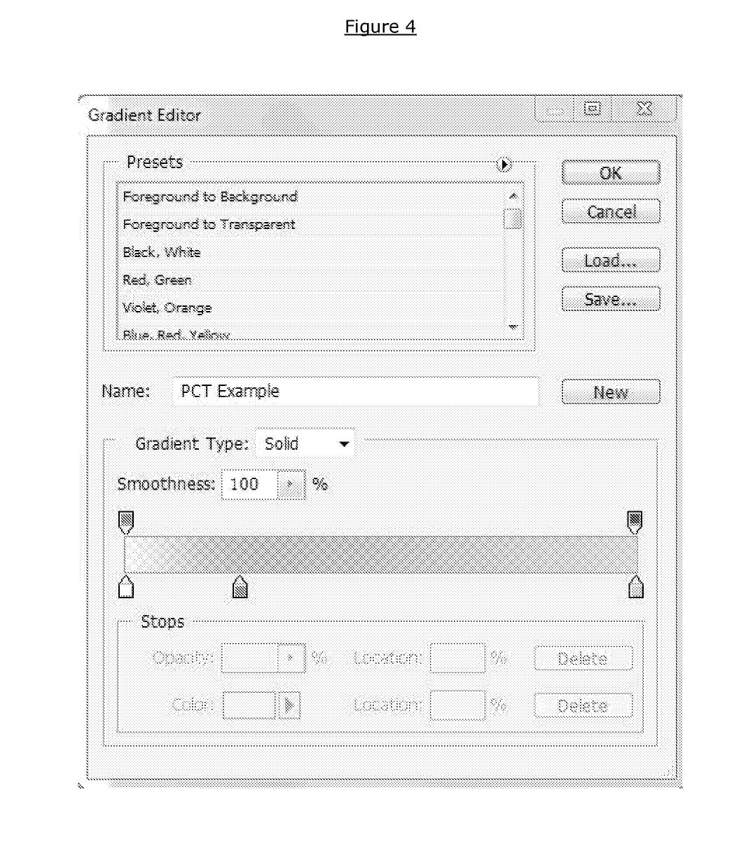

FIG. 4 shows a computer gradient editor interface which demonstrates a gradient during production:
(a) Bar indicates the colour gradient (solid type);
(b) Stop points below the line indicate colour at those points;
(c) Diamond markers below the line indicate the positioning of colour transition points;
(d) Stop points above the bar indicate the points where opacity changes. The percentage would be shown in the opacity box if a stop point were selected;
(e) Diamond markers would appear above the line to indicate the location of the opacity transition points were opacity being edited;
(f) Overall smoothness of the transition indicated by the “smoothness” value.

1. An image for representing a wine, which includes
(a) an image that includes at least one illustration of an item, and
(b) each item indicating at least one characteristic of the wine,
wherein the items do not include grapes and/or wine, and
wherein the image represents the experience or characteristics of the wine which characteristics vary during the consumption of the wine while the wine is being smelt and tasted in the mouth.

2.-4. (canceled)

5. The image of claim 1, wherein the image includes at least one item and/or consist of variable colour.

6. The image of claim 1, wherein the characteristic is selected from the group consisting of
(a) the flavour of the wine,
(b) the body of the wine; and
(c) the acidity of the wine.

7-13. (canceled)

14. The image of claim 1, wherein the image indicates the changes in taste, and the items in the image are positioned in an arrangement in which the order of the items in the arrangement indicates how the experience of the wine develops over time.

15. The image of claim 1, wherein the arrangement extends across the image as:
(a) items at one end of the arrangement indicate an initial experience and items at an opposite ends of the arrangement indicate a finish, items in a middle of the arrangement indicate a mid-palate experience, the mid-palate experience being the experience into which the initial experience develops into over time, the mid-palate experience developing over time into the finish;
(b) items at an end of the arrangement indicating the initial experience, and items at an opposite end of the arrangement indicating the finish; and
(c) diagonally across the image with items at an end of the arrangement proximate the top left corner and/or section of the image indicate an initial experience, and items at an opposite end of the arrangement proximate the bottom right corner and/or section of the picture indicate the finish.

16. The image of claim 15, wherein items which indicate the finish are depicted as being in front of the items which indicate the mid-palate experience, which are depicted as being in front of the items indicating the initial experience.

17. The image of claim 1, wherein color used in the background of the image varies across the image to indicate how the experience of the wine develops over the length of time that the wine is in the mouth.

18.-39. (canceled)

40. A method of representing wine, said method comprising:
(a) identifying at least one characteristic of at least one wine;
(b) associating at least one item to indicate at least one identified characteristic of the wine;
(c) creating an image for representing wine incorporating at least one illustration of the item(s); and
(d) generating a label which include the image,
wherein the image represents the experience or characteristics of the wine, which characteristics vary during the consumption of the wine, while the wine is being smelt and tasted in the mouth.

41. The method of claim 40, wherein the characteristic(s) of the wine(s) are identified by means of tasting the wine(s) and/or laboratory analysis of the wine(s).

42.-51. (canceled)

52. A container comprising:
a vessel,
wine disposed in the vessel, and
a label affixed to the vessel, the label comprising an image, the image including at least one illustration of an item, and each item indicating at least one characteristic of the wine,
wherein the items do not include grapes and/or wine and
wherein the image represents the experience or characteristics of the wine, which characteristics vary during the consumption of the wine while the wine is being smelt and tasted in the mouth.

53. The container of claim 52, wherein the image represents an experience or characteristics of the wine vary during the consumption of the wine, while the wine is being smelt and tasted in the mouth.

54. The container of claim 53, wherein the image indicates the changes in taste, and the items in the image are positioned in an arrangement in which the order of the items in the arrangement indicates how the experience of the wine develops over time.

55. The container of claim 54, wherein the arrangement extends across the image as:
items at one end of the arrangement indicate an initial experience and items at an opposite ends of the arrangement indicate a finish, items in a middle of the arrangement indicate a mid-palate experience, the mid-palate experience being the experience into which the initial experience develops into over time, the mid-palate experience developing over time into the finish;
items at an end of the arrangement indicate the initial experience, and items at an opposite end of the arrangement indicate the finish; and
diagonally across the image with items at an end of the arrangement proximate the top left corner and/or section of the image indicate an initial experience, and items at an opposite end of the arrangement proximate the bottom right corner and/or section of the picture indicate the finish.

56. The container of claim 54, wherein items which indicate the finish are depicted as being in front of the items which indicate the mid-palate experience, which are depicted as being in front of the items indicating the initial experience.

57. The container of claim 54, wherein color used in a background varies across the image to indicate how the experience of the wine develops over the length of time that the wine is in the mouth.

58. The method of claim 40, wherein the image represents an experience or characteristics of the wine, which characteristics vary during the consumption of the wine while the wine is being smelt and tasted in the mouth.

59. The method of claim 40, wherein the image indicates the changes in taste, and the items in the image are positioned in an arrangement in which the order of the items in the arrangement indicates how the experience of the wine develops over time.

60. The method of claim 40, wherein the arrangement extends across the image as:
items at one end of the arrangement indicate an initial experience and items at an opposite ends of the arrangement indicate a finish, items in a middle of the arrangement indicate a mid-palate experience, the mid-palate experience being the experience into which the initial experience develops into over time, the mid-palate experience developing over time into the finish;
items at an end of the arrangement indicate the initial experience, and items at an opposite end of the arrangement indicate the finish; and
diagonally across the image with items at an end of the arrangement proximate the top left corner and/or section of the image indicate an initial experience, and items at an opposite end of the arrangement proximate the bottom right corner and/or section of the picture indicate the finish.

61. The method of claim 40, wherein items which indicate the finish are depicted as being in front of the items which indicate the mid-palate experience, which are depicted as being in front of the items indicating the initial experience.

62. The method of claim 40, wherein color used in a background varies across the image to indicate how the experience of the wine develops over the length of time that the wine is in the mouth.
